(19) United States
(12) Patent Application Publication
(10) Pub. No.: US 2012/0042059 A1
(43) Pub. Date: Feb. 16, 2012

(54) METHOD FOR INDICATING A SERVICE PRIORITY UPDATE, SERVICE PRIORITY UPDATE METHOD AND APPARATUS

(75) Inventors: Shuang Tian, Shenzhen (CN); Hui Ni, Beijing (CN); Shiyong Tan, Beijing (CN); Yan Li, Shenzhen (CN)

(73) Assignee: Huawei Technologies Co., Ltd., Shenzhen (CN)

(21) Appl. No.: 13/279,988

(22) Filed: Oct. 24, 2011

Related U.S. Application Data
(63) Continuation of application No. PCT/CN2010/072125, filed on Apr. 23, 2010.

(30) Foreign Application Priority Data
Apr. 24, 2009 (CN) 200910082564.3

(51) Int. Cl. G06F 15/173

(52) U.S. Cl. 709/223

(57) ABSTRACT

Embodiments of the present invention provide a method for indicating the service priority update, a service priority update method, and an apparatus. The method for indicating the service priority update includes: A priority management functional entity receives a service priority update request message sent by a user, where the update request message includes a service type identifier and a priority update indication identifier corresponding to the service type identifier; and the priority management functional entity sends a service priority update instruction message to a network side according to the update request message, where the update instruction message is used to instruct the network side to process a service corresponding to the service type identifier according to a priority level corresponding to the priority update indication identifier. In the embodiments of the present invention, priority control is exercised on all types of services of the user in an emergency.

This application is a continuation of International Application No. PCT/CN2010/072125, filed on Apr. 23, 2010, which claims priority to Chinese Patent Application No. 200910082564.3, filed on Apr. 24, 2009, both of which are hereby incorporated by reference in their entireties.

### FIELD OF THE INVENTION

The present invention relates to the field of communications technologies, and in particular, to a method for indicating a service priority update, a service priority update method, and an apparatus.

### BACKGROUND OF THE INVENTION

An Emergency Telecommunications Service (ETS) is a national service. An ETS user may use a communications service with a higher priority than a common user. Such a communications service includes a voice service, a video service, and a data service. For the ETS user, the ETS may be in an active state or an inactive state. When the ETS is in the inactive state, a priority of the ETS user is no higher than a priority of a common user; when the ETS is in the active state, the ETS user enjoys a priority corresponding to a user level of the ETS user in service processing. The priority processing includes that each network element in a network preferentially processes a service of the ETS user. When a disaster or an emergency occurs, the network may be congested, and a network service may be unavailable to a common user. In this case, the ETS user needs to activate an ETS state of the ETS user. In this way, the priority of a service related to the ETS user is increased, and the service related to the ETS user is processed preferentially.

Policy and Charging Control (PCC) architecture includes: a Policy Control and Charging Rules Function (PCRF), a Policy and Charging Enforcement Function (PCEF), a Subscription Profile Repository (SPR), and an Application Function (AF). An existing ETS may be carried out based on the PCC architecture. For example, an AF sends an “Application/Service Info” message to the PCRF to send a session update request (for example, request increase or decrease of a priority of a session).

In a process of implementing the present invention, the inventor finds at least the following problems in the prior art: In the prior art, after the AF sends a session update request to the PCRF, the PCRF can change only a priority of sessions related to this AF, but cannot update priorities of multiple types of services, which leads to low Quality of Service (QoS).

### SUMMARY OF THE INVENTION

Embodiments of the present invention provide a method for indicating a service priority update, a service priority update method, and an apparatus to update a priority of a type of, multiple types of, or all types of services as required by a user and overcome a defect that only a priority of sessions related to a single AF can be changed in the prior art.

An embodiment of the present invention provides a method for indicating a service priority update, including:

receiving, by a priority management function entity, a service priority update request message sent by a user, where the update request message includes a service type identifier and a priority update indication identifier corresponding to the service type identifier; and

sending, by the priority management functional entity, a service priority update instruction message to a network side according to the update request message, where the update instruction message is used to instruct the network side to process a service corresponding to the service type identifier according to a priority level corresponding to the priority update indication identifier.

An embodiment of the present invention provides a service priority update method, including:

receiving a service priority update instruction message, where the update instruction message includes a service type identifier and a priority update indication identifier corresponding to the service type identifier; and

processing a service corresponding to the service type identifier according to a priority level corresponding to the priority update indication identifier.

An embodiment of the present invention provides a priority management functional entity device, including:

a first receiving module, configured to receive a service priority update request message sent by a user, where the update request message includes a service type identifier and a priority update indication identifier corresponding to the service type identifier; and

a first sending module, configured to send a service priority update instruction message to a network side according to the update request message, where the update instruction message is used to instruct the network side to process a service corresponding to the service type identifier according to a priority level corresponding to the priority update indication identifier.

An embodiment of the present invention provides a PCRF device, including:

a second receiving module, configured to receive a service priority update instruction message, where the update instruction message includes a service type identifier and a priority update indication identifier corresponding to the service type identifier;

a first processing module, configured to create a service priority update rule according to the service type identifier and the priority update indication identifier; and

a second sending module, configured to send the service priority update rule to a PCEF, and instruct the PCEF to process a service corresponding to the service type identifier according to a priority level corresponding to the priority update indication identifier.

An embodiment of the present invention provides a serving Access Service Network (ASN) functional entity device, including:

a third receiving module, configured to receive a service priority update instruction message, where the update instruction message includes a service type identifier and a priority update indication identifier corresponding to the service type identifier; and

a second processing module, configured to process a service corresponding to the service type identifier according to a priority level corresponding to the priority update indication identifier.

An embodiment of the present invention provides a network system, including:

a priority management functional entity device, configured to: receive a service priority update request message sent by a user, where the update request message includes a service type identifier and a priority update indication identifier corresponding to the service type identifier; and send a service priority update instruction message to a network side according to the update request message; and

a PCRF device, configured to: receive the service priority update instruction message, create a service priority update rule according to the service type identifier and the priority update indication identifier, send the service priority update rule to a PCEF, and instruct the PCEF to process a service corresponding to the service type identifier according to a priority level corresponding to the priority update indication identifier.

An embodiment of the present invention provides a network system, including: a priority management functional entity device, a serving ASN functional entity device, and an SPR or an Authentication, Authorization and Accounting (AAA) server, where:

the priority management functional entity device is configured to: receive a service priority update request message sent by a user, where the update request message includes a service type identifier and a priority update indication identifier corresponding to the service type identifier; and send a service priority update instruction message to the SPR or the AAA server according to the update request message; and

the serving ASN functional entity device is configured to: receive the service priority update instruction message, and process a service corresponding to the service type identifier according to a priority level corresponding to the priority update indication identifier.

The method for indicating the service priority update, the service priority update method, and the apparatus provided in the embodiments of the present invention exercise priority control on all types of services of the user, and may update the priority of a type of, multiple types of, or all types of services as required by the user, which improves the QoS.

### BRIEF DESCRIPTION OF THE DRAWINGS

FIG. 1 is a schematic diagram of PCC architecture according to an embodiment of the present invention;

FIG. 2 is a flowchart of a method for indicating the service priority update according to an embodiment of the present invention;

FIG. 3 is a flowchart of a service priority update method according to an embodiment of the present invention;

FIG. 4 is a flowchart of a service priority update method according to an embodiment of the present invention;

FIG. 5 is a signaling flowchart of a method for updating a priority of a user service according to a first embodiment of the present invention;

FIG. 6 is a signaling flowchart of a method for updating a priority of a user service according to a second embodiment of the present invention;

FIG. 7 is a signaling flowchart of a method for updating a priority of a user service according to a third embodiment of the present invention;

FIG. 8 is a signaling flowchart of a method for updating a priority of a user service according to a fourth embodiment of the present invention;

FIG. 9 is a signaling flowchart of a method for updating a priority of a user service according to a fifth embodiment of the present invention;

FIG. 10 is a schematic structural diagram of a priority management functional entity device according to an embodiment of the present invention;

FIG. 11 is a schematic structural diagram of a PCRF device according to an embodiment of the present invention;

FIG. 12 is a schematic structural diagram of a serving ASN functional entity device according to an embodiment of the present invention;

FIG. 13 is a schematic structural diagram of a network system according to a first embodiment of the present invention; and

FIG. 14 is a schematic structural diagram of a network system according to a second embodiment of the present invention.

### DETAILED DESCRIPTION OF THE EMBODIMENTS

Technical solutions of the embodiments of the present invention are further described with reference to the accompanying drawings and exemplary embodiments.

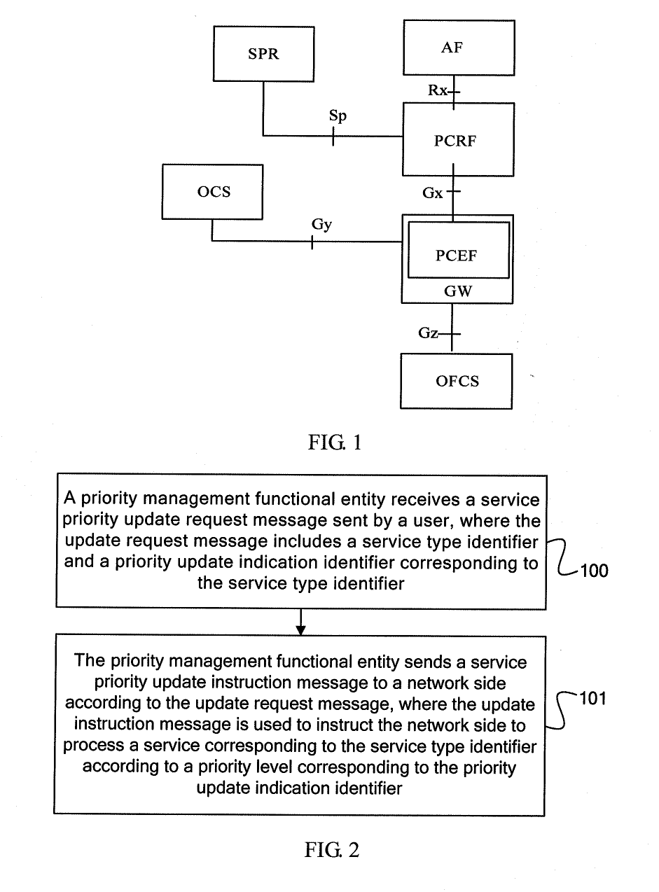

A communications network evolves from a conventional circuit-switched network to an IP packet-switched network that separates a control function from a bearer function, and then to an all-IP-based multimedia network. In a process of evolution to the all-IP-based network, because an IP network may provide more types of services such as multimedia calling, file downloading, and web browsing, the network needs to be able to detect different service streams, implement statistics on charging information such as traffic and duration, and report the charging information to a billing center. PCC architecture is defined by organizations such as the 3rd Generation Partnership Project (3GPP) and the Worldwide Interoperability for Microwave Access (WiMAX) Forum. By using the PCC architecture, the network may detect different service streams, and implement requirements such as QoS control and charging statistics for the service streams. FIG. 1 is a schematic diagram of PCC architecture according to an embodiment of the present invention. As shown in FIG. 1, PCC architecture defined in the 3GPP TS 23.203 protocol includes the following functional entities:

PCRF: The PCRF decides a corresponding policy according to a restriction for a user to access a network, an operator policy, subscription data (obtained from an SPR) of the user, and ongoing service information (obtained from an AF) of the user, and provides the policy for a PCEF; the PCEF enforces the policy. The policy includes: a rule for detecting a service data stream (which is a set of IP streams for implementing a service such as a voice service), information indicating whether access control is exercised, QoS corresponding to the service data stream, and a stream-based charging rule.

PCEF: The PCEF enforces the policy delivered or specified by the PCRF. Specifically, the PCEF detects and measures a service data stream, ensures QoS of the service data stream, processes user-plane traffic, and triggers control-plane session management. Depending on an undertaken function, the PCEF may be a Gateway GPRS Support Node (GGSN, where GPRS is short for General Packet Radio Service), a gateway (GW), and so on.

SPR: The SPR provides the PCRF with subscription data of the user.

AF: The AF dynamically provides the PCRF with application-layer session information, and the PCRF dynamically generates or modifies the corresponding rule according to the information.

Another two functional entities include an Online Charging System (OCS) responsible for online charging and an Offline Charging System (OFCS) responsible for offline charging.

Each interface is described as follows:

Rx reference point: The Rx reference point enables the AF to deliver information related to an application layer, where the information includes but is not limited to an IP filter that is configured to identify a service data stream and bandwidth information required by an application or a medium. This reference point uses a Diameter protocol that is defined by the Internet Engineering Task Force (IETF);

Gx reference point: The Gx interface enables the PCRF to dynamically control a PCC rule enforced on the PCEF. This reference point implements the following functions: creating, maintaining and terminating an IP Connectivity Access Network (IP-CAN) session, enabling the PCEF to request the PCC rule from the PCRF, enabling the PCRF to provide the PCC rule for the PCEF, and negotiating a mode of creating an IP-CAN bearer. This reference point uses the Diameter protocol defined by the IETF;

Sp reference point: The Sp reference point enables the PCRF to request subscription information of the user from the SPR, where the subscription information is used to determine an IP-CAN transport-layer policy. Currently, this interface is a private interface (which is defined by an equipment vendor, and is not public); and

a Gy reference point is used for offline charging, and a Gz reference point is used for online charging.

The PCRF only changes a priority of a session related to the AF that sends an update request in the prior art, but cannot change a priority of a type of, multiple types of, or all types of services. The solution is: A priority management functional entity is set in the network to uniformly manage priority information of all services of an ETS user so that the ETS user may change the priority of a type of, multiple types of, or all types of services as required. Optionally, priority change information is notified to another related functional entity.

FIG. 2 is a flowchart of a method for indicating the service priority update according to an embodiment of the present invention. As shown in FIG. 2, the method includes:

Step 100: A priority management functional entity receives a service priority update request message sent by a user, where the update request message includes a service type identifier and a priority update indication identifier corresponding to the service type identifier.

When the user needs to activate an ETS state or increase/decrease the priority of a type of, multiple types of, or all types of services, the user interacts with the priority management functional entity. The priority management functional entity is responsible for managing a priority of the user. The priority management functional entity may parse a priority change request sent by the user, and is directly or indirectly connected to a PCRF. The user sends a service priority update request message to the priority management functional entity such as an ETS server, where the update request message carries corresponding information such as a service type identifier and a priority update indication identifier corresponding to the service type identifier; and instructs the ETS server to update a priority of a service corresponding to the service type identifier according to the priority update indication identifier, for example, activate the ETS state, that is, selecting a higher priority, or deactivate the ETS state, that is, selecting a common priority. The priority management functional entity receives the service priority update request message sent by the user, where the update request message may carry one or several service type identifiers or a special identifier that identifies all service types. Specifically, if the update request message carries only one service type identifier, it indicates that the user needs to update priority information of only one type of services; if the update request message carries several service type identifiers, it indicates that the user needs to update priority information of several types of services at the same time; if the update request message carries a special identifier such as “ALL” that is used to identify all service types, it indicates that the user needs to update priority information of all types of services. Moreover, a priority update indication identifier includes a priority state update indication identifier or a priority level update indication identifier. Specifically, if a priority of a service of a user includes only an ETS-active state and an ETS-inactive state, a priority state update indication identifier may be sent to the ETS server to indicate that the user needs to update from the ETS-inactive state to the ETS-active state, and a priority level of a service in the ETS-active state is higher than a priority level of a service in the ETS-inactive state. If a priority of a service of a user includes not only the ETS-active state and the ETS-inactive state, but also multiple priorities for the user to select in the ETS-active state (for example, the priority is divided into 3 levels in the ETS-active state), the user may select a corresponding priority level according to a priority level update indication identifier corresponding to each priority level. In both of the foregoing two circumstances, an identifier transmitted between the user and the priority management functional entity may be preset.

For example, for an ETS service, if an ETS user needs to activate the ETS state and increase priorities of a voice service and a video service to an ETS priority, the ETS user interacts with the ETS server by sending a service priority update request message to the ETS server, where the update request message includes a service type identifier of the voice service, a service type identifier of the video service, and a priority state update indication identifier, and is used to instruct the ETS server to activate the ETS state of the ETS user and set the priorities of the voice service and the video service to the ETS priority. Step 101: The priority management functional entity sends a service priority update instruction message to a network side according to the update request message, where the update instruction message is used to instruct the network side to process a service corresponding to the service type identifier according to a priority level corresponding to the priority update indication identifier.

The ETS server receives the request from the user, and directly or indirectly sends the update request message to the PCRF. The process of indirectly sending the update request message to the PCRF includes: for example, the ETS server sends a service priority update instruction message to an SPR or an AAA server, and the SPR or the AAA server forwards the update instruction message to the PCRF, where the ETS server sends the update instruction message to the SPR in a 3GPP network based on PCC architecture and the ETS server sends the update instruction message to the AAA server in a WiMAX network based on PCC architecture; or the ETS server sends a service priority update instruction message to the SPR or the AAA server, the SPR or the AAA server forwards the update instruction message to the PCEF, and then the PCEF forwards the update instruction message to the PCRF; or the ETS server sends the update instruction message to a Universal Services Interface (USI) server, and the USI server forwards the update instruction message to the PCRF. The foregoing process is implemented in the PCC architecture. In a WiMAX system that is not based on the PCC architecture, the ETS server sends the update instruction message to the SPR or the AAA server, and the SPR or the AAA server forwards the update instruction message to a serving ASN functional entity. The priority management functional entity sends the update instruction message to a network-side functional entity to instruct a functional entity such as the PCRF or the serving ASN functional entity to process the service corresponding to the service type identifier according to the priority level corresponding to the priority update indication identifier. The foregoing provides only several implementation modes for the priority management functional entity to indirectly send the update request message to the PCRF. It is apparent that this embodiment of the present invention is not limited to the foregoing implementation modes. Another implementation mode of indirectly sending the update request message is also covered in the protection scope of the present invention.

In the method for indicating the service priority update provided in this embodiment, a newly-added priority management functional entity for uniformly managing priority information of user services exercises priority control on various types of services of the user, and may update the priority of a type of, multiple types of, or all types of services as required by the user, which improves QoS.

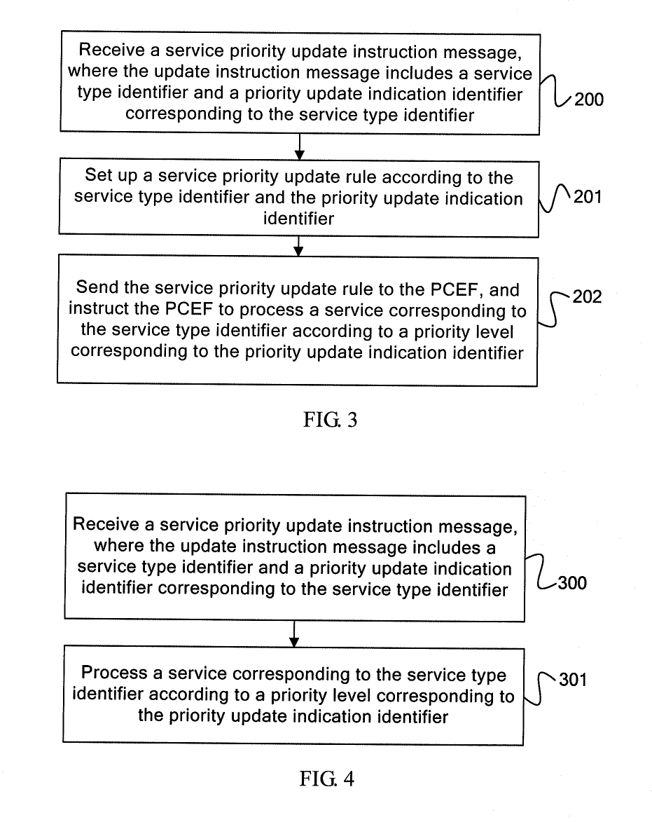

FIG. 3 is a flowchart of a service priority update method according to an embodiment of the present invention. As shown in FIG. 3, the method includes:

Step 200: Receive a service priority update instruction message, where the update instruction message includes a service type identifier and a priority update indication identifier corresponding to the service type identifier.

Based on the foregoing embodiment, a PCRF directly or indirectly receives the service priority update instruction message sent by a priority management functional entity. The update instruction message includes a service type identifier and a priority update indication identifier corresponding to the service type identifier. The priority update indication identifier may include a priority state update indication identifier or a priority level update indication identifier; and the service type identifier includes one or several service type identifiers, or a special identifier that is used to identify all types of services.

Step 201: Create a service priority update rule according to the service type identifier and the priority update indication identifier. The PCRF formulates a corresponding PCC rule, that is, a service priority update rule, according to the received update instruction message. Specifically, the PCRF needs to know an updated priority level, determine all sessions related to a service type whose priority is required to be updated by the user, and finally, associate these sessions with the new priority level to form a new rule. It should be noted that if a user sets up a new session actively or passively, for example, a network requests setting up of a session with the user, and a type of this session is the same as the service type whose priority needs to be updated, a priority level of the new session is determined according to the priority update indication identifier. That is, an updated priority is applied to the new session.

In this step, in this embodiment of the present invention, if a service priority update request message sent by the user does not specifies the service type whose priority needs to be updated, namely, the update request message does not carry the service type identifier or a corresponding priority level, the PCRF may determine all sessions involved in the priority update according to a locally configured policy, and associate the sessions with the new priority level to form a new rule. In other words, when a technical solution of the present invention solves a problem of updating a priority of only a session related to an AF that sends an update request in the prior art, association is performed according to a service type in the service priority update request message, and moreover, the PCRF may independently associate and confirm related sessions.

Step 202: Send the service priority update rule to a PCEF and instruct the PCEF to process a service corresponding to the service type identifier according to the priority level corresponding to the priority update indication identifier.

Optionally, the PCRF sends a service priority update notification message to all functional entities related to the sessions determined by the service type identifier. The notification message includes the service type identifier and the priority level corresponding to the priority update indication identifier. The functional entities may include an SPR or an AAA server, and an IP Multimedia Subsystem (IMS) AF. For example, an ETS user requests an increase of a priority of all voice services of the user, and an ETS server sends the message to the PCRF. Therefore, after the priority of all voice sessions is changed, the updated priority information is notified to all AFs related to the voice services.

The service priority update method provided in this embodiment is based on PCC architecture, and exercises priority control on various types of services of the user in an emergency. An ETS imposes a new requirement on the PCRF, that is, the PCRF needs to increase a priority of a type of, multiple types of, or all types of services of the user at the same time, which may involve sessions related to several AFs, and therefore improves QoS.

FIG. 4 is a flowchart of a service priority update method according to an embodiment of the present invention. As shown in FIG. 4, the method includes:

Step 300: Receive a service priority update instruction message, where the update instruction message includes a service type identifier and a priority update indication identifier corresponding to the service type identifier.

In a system that is not based on PCC architecture, such as a WiMAX system, a priority management functional entity sends the service priority update instruction message to an SPR or an AAA server, and the SPR or the AAA server forwards the update instruction message to a serving ASN functional entity. The serving ASN functional entity receives the service priority update instruction message. The priority update indication identifier in the update instruction message includes a priority state update indication identifier or a priority level update indication identifier; and the service type identifier includes one or several service type identifiers, or a special identifier that is used to identify all types of services.

Step 301: Process a service corresponding to the service type identifier according to a priority level corresponding to the priority update indication identifier.

The serving ASN functional entity updates, according to the indication, a priority of a service type specified by a user to a priority expected by the user, and processes a corresponding service according to a new priority. The serving ASN functional entity may also notify a priority update message to another AF related to the service.

The technical solution of this embodiment exercises priority control on all types of services of the user in an emergency without being based on PCC architecture. An ETS imposes a new requirement on the serving ASN functional entity, that is, the serving ASN functional entity needs to increase a priority of a type of, multiple types of, or all types of services of the user at the same time, which may involve sessions related to several AFs, and therefore improves QoS.

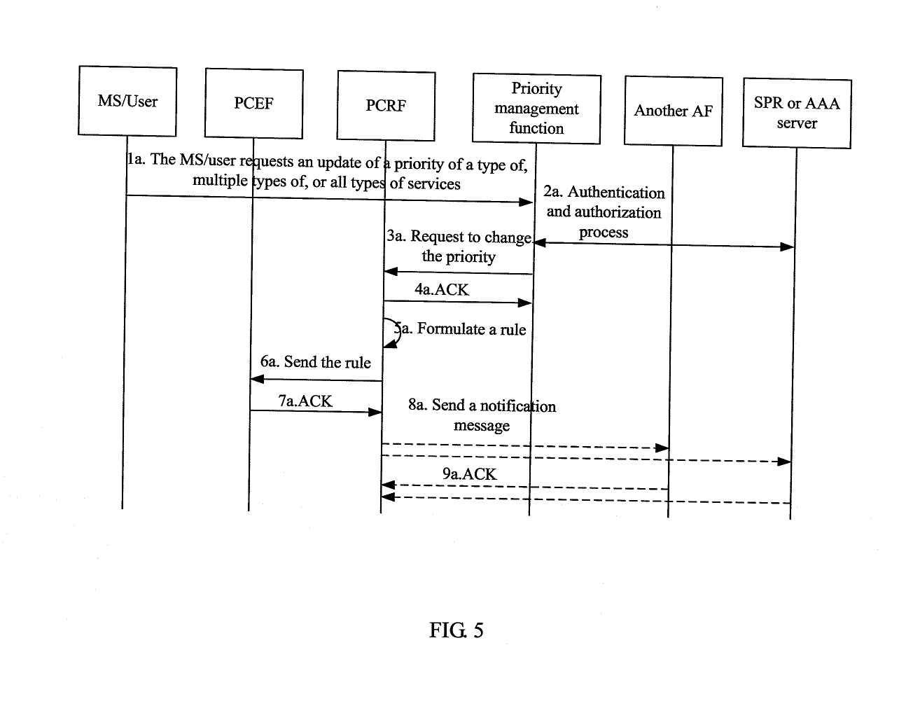

FIG. 5 is a signaling flowchart of a method for updating a priority of a user service according to a first embodiment of the present invention. A priority management functional entity may directly or indirectly interact with a PCRF. In this embodiment, the priority management functional entity directly interacts with the PCRF. As shown in FIG. 5, the procedure includes:

Step 1a: A Mobile Station (MS)/user interacts with a priority management functional entity to request an update of a priority of a type of, multiple types of, or all types of services.

In this process, different identifiers need to be defined for different service types; and a special indication may be used for a request for changing a priority of all services of the user. The MS/user interacts with the priority management functional entity in two modes. One mode is: The MS/user directly sends a request to the priority management functional entity; and the other mode is: The MS/user sends a request to an IMS server first, and then the IMS server forwards the request to the priority management functional entity.

Step 2a: The priority management functional entity may authenticate and authorize the request sent by the MS/user.

Optionally, this step may also be performed through interaction with an SPR or an AAA server.

Step 3a: The priority management functional entity notifies a service type whose priority needs to be updated and a new priority level to the PCRF.

The priority management functional entity may send an identifier corresponding to the specified service type. If the priority of all services needs to be updated, a special identifier such as “ALL” may be used to represent all services. In addition, the new priority level may be stored in the PCRF, or the SPR, or the AAA server beforehand. In this way, the priority management functional entity needs to indicate only a service type whose priority needs to be updated, and a priority state such as an ETS-active state and an ETS-inactive state.

Step 4a: The PCRF returns an Acknowledge message.

Step 5a: The PCRF formulates a corresponding rule according to information received in step 3a.

The PCRF determines all sessions related to the received service type, and associates the new priority level with the sessions to form a new session priority rule. Meanwhile, the PCRF may need to determine one or multiple AFs related to the sessions. If the user actively or passively sets up a new session and the type of the new session is the same as the service type whose priority needs to be updated, the updated priority is applied to this session.

Step 6a: The PCRF sends the new priority rule to the PCEF.

Step 7a: The PCEF enforces the rule, and returns an ACK message.

Step 8a: The PCRF notifies a priority update message to the one or multiple AFs determined in step 5a.

Step 9a: The AF returns an ACK message.

The AF may subscribe to this notification message from the PCRF before step 1a, and accordingly, the PCRF may notify the priority update to the AF in step 8a. If the authentication/authorization process in step 2a does not involve the SPR or the AAA server, the notification process in step 8a may further involve the SPR or the AAA server, that is, a change of a priority state of the user is notified to the SPR or the AAA server.

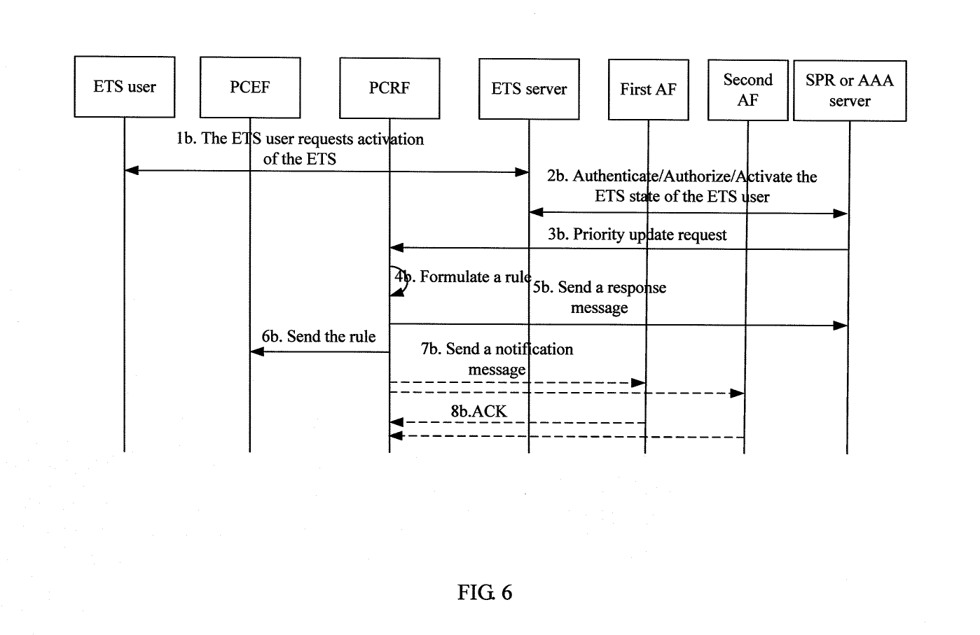

FIG. 6 is a signaling flowchart of a method for updating a priority of a user service according to a second embodiment of the present invention. In this embodiment, an ETS user requests activation of an ETS state and an increase of a priority of all data downloading services of the ETS user to an ETS priority; a priority management functional entity is an ETS server, which is indirectly connected to a PCRF through an SPR or an AAA server. As shown in FIG. 6, the procedure includes:

Step 1b: An ETS instructs an ETS server to activate the ETS state of the ETS user and increase the priority of all data downloading services to the ETS priority.

Step 2b: The ETS server receives a request from the ETS user, interacts with the SPR or the AAA server, instructs the SPR or the AAA server to authenticate and authorize the request from the user, changes the ETS state of the user to an active state, and specifies that the priority of the data downloading services of the user is increased to the ETS priority. The ETS priority level may be provided by the ETS server for the SPR or the AAA server, or stored in the SPR or the AAA server beforehand.

Step 3b: The SPR or the AAA server sends an ETS state activation message to the PCRF, and instructs the PCRF to increase the priority of the data downloading services of the ETS user to the ETS priority.

Step 4b: The PCRF first determines all data downloading sessions of the ETS user. In this embodiment, the user has two data downloading sessions with a first AF and a second AF respectively. The PCRF increases the priority of the two sessions to the ETS priority. If the user sets up a new data downloading session, the ETS priority is still applied to the new session.

Step 5b: The PCRF sends a response message to the SPR or the AAA server.

Step 6b: The PCRF sends a new priority rule determined in step 4b to the PCEF, and instructs the PCEF to enforce the new priority rule.

Step 7b: The PCRF notifies a priority update message to the first AF and the second AF.

Step 8b: The first AF and the second AF return an ACK message.

Steps 7b and 8b are optional.

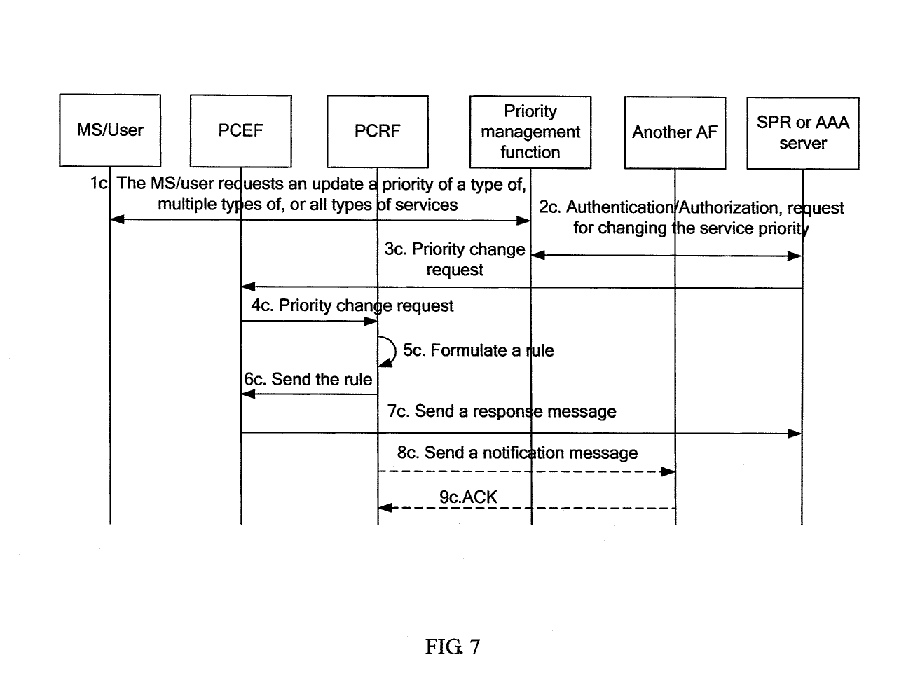

FIG. 7 is a signaling flowchart of a method for updating a priority of a user service according to a third embodiment of the present invention. In this embodiment, a priority management functional entity is connected to a PCRF through an SPR or an AAA server and a PCEF; and a user requests a decrease of a priority of a voice service and a video service. This procedure is also applicable to activation and deactivation of an ETS. As shown in FIG. 7, the procedure includes:

Step 1c: An MS/user interacts with the priority management functional entity to request the decrease of the priority of the voice service and the video service to a specific priority.

The MS/user interacts with the priority management functional entity in two modes. One mode is: The MS/user directly sends a request to the priority management functional entity; and the other mode is: The MS/user sends a request to an IMS server first, and then the IMS server forwards the request to the priority management functional entity.

Step 2c: The priority management functional entity receives a request from the MS/user, interacts with the SPR or the AAA server to authenticate and authorize the request from the MS/user, and specifies that the priority of the voice service and the video service is decreased to a level required by the MS/user.

Step 3c: The SPR or the AAA server sends the priority change request to the PCEF, and instructs the PCEF to forward the request to the PCRF.

Step 4c: The PCEF forwards the request to the PCRF.

Step 5c: The PCRF decreases the priority of all voice services and video services of the MS/user to a required priority according to the received indication, and the decreased priority is also applied to a new voice service and a new video service of the MS/user.

Step 6c: The PCRF sends a new priority rule to the PCEF.

Step 7c: The PCEF enforces the rule, and sends a response message to the SPR or the AAA server.

Step 8c: The PCRF notifies a priority update message to another AF related to the voice services and video services of the MS/user.

Step 9c: Another AF returns an ACK message.

It should be noted that steps 8c and 9c are optional. If another AF subscribes to the priority update message from the PCRF at the stage of initiating a service of the MS/user, the PCRF may notify the corresponding AF as described in steps 8c and 9c.

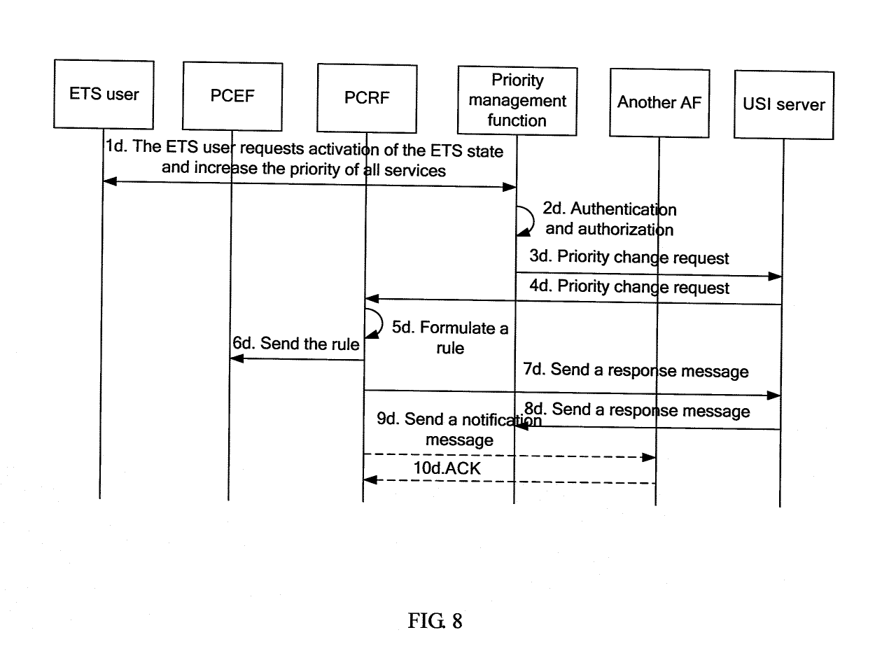

FIG. 8 is a signaling flowchart of a method for updating a priority of a user service according to a fourth embodiment of the present invention. In this embodiment, an ETS user requests activation of an ETS state and an increase of a priority of all services of the ETS user to a specific ETS priority level; an ETS server is connected to a PCRF through a USI server; and a priority management functional entity is the ETS server. As shown in FIG. 8, the procedure includes:

Step 1d: The ETS user instructs the ETS server to increase the priority of all services of the ETS user to an ETS priority. Particularly, for a request for an increase of the priority of all services, a special identifier such as “ALL” may be used to represent all services, or all service types may be exhaustively specified in a request message.

Step 2d: The ETS server receives a request from the ETS user, and authenticates and authorizes the ETS request. This process may include interaction with the SPR or the AAA server.

Step 3d: After the authentication and authorization succeed, the ETS server sends the priority update request of the ETS user to the USI server. The message may include a special identifier to represent all services, and include the ETS priority level.

Step 4d: The USI server sends the priority update request to the PCRF.

Step 5d: After receiving the request, the PCRF increases the priority of all sessions related to the ETS user to the ETS priority, and the ETS priority is also applied to a new session related to the ETS user.

Step 6d: The PCRF sends a new rule to the PCEF, and the PCEF enforces the rule.

Step 7d: The PCRF sends a response message to the USI server.

Step 8d: The USI server sends a response message to the ETS server.

Step 9d: The PCRF notifies a priority update message to another related AF.

Step 10d: The AF returns an ACK message.

It should be noted that steps 9d and 10d are optional. If another AF subscribes to the priority update message from the PCRF at the stage of initiating a service of the ETS user, the PCRF may notify the corresponding AF as described in steps 9d and 10d.

The procedures described in the foregoing embodiments are also applicable to ETS user deactivation. In the case of ETS deactivation, a priority of a type of, multiple types of, or all types of services of a user is decreased from a high ETS priority to a low common priority.

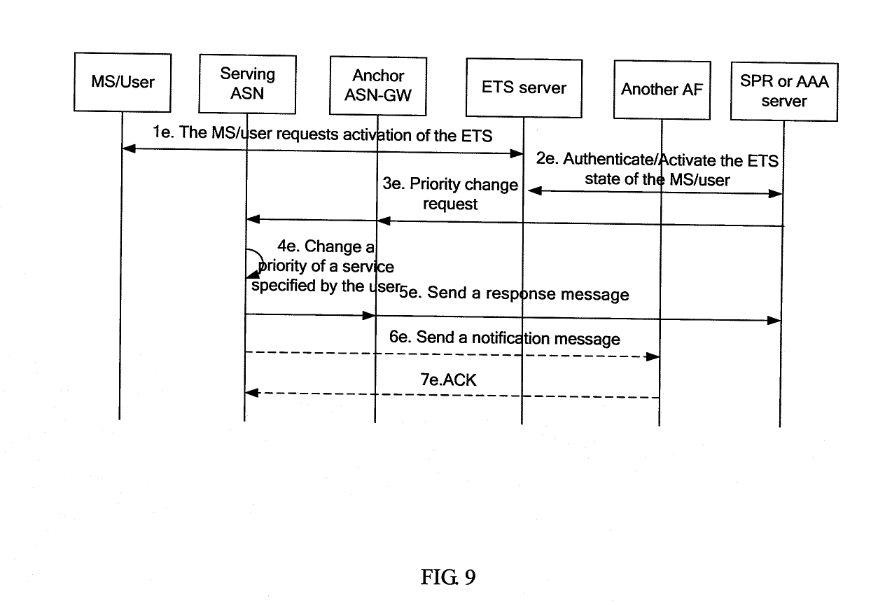

FIG. 9 is a signaling flowchart of a method for updating a priority of a user service according to a fifth embodiment of the present invention. For example, for a WiMAX system that is not based on PCC architecture, priority control on an ETS may be implemented through a procedure in this embodiment. The detailed procedure is similar to the foregoing procedures. The WiMAX system includes neither a PCRF nor a PCEF. Therefore, in this embodiment, a serving ASN functional entity replaces the PCRF and the PCEF to control and execute a change of priorities of various services. As shown in FIG. 9, the procedure includes:

Step 1e: An MS/user instructs an ETS server to increase a priority of a type of, multiple types of, or all types of services of the MS/user to an ETS priority.

Step 2e: The ETS server receives a request from the MS/user, interacts with the SPR or the AAA server to authenticate and authorize the request from the MS/user, changes an ETS state of the MS/user to an active state, and specifies a service type whose priority is expected (by the MS/user) to be increased for the SPR or the AAA server.

Step 3e: The SPR or the AAA server directly or indirectly sends the priority update request message to the serving ASN functional entity, and instructs the serving ASN functional entity to increase the priority of the service specified by the MS/user to the ETS priority.

Step 4e: The serving ASN functional entity increases, according to the received instruction, the priority of the service type specified by the MS/user to the priority expected by the user.

Step 5e: The serving ASN functional entity sends a response message to the SPR or the AAA server.

Step 6e: The serving ASN functional entity notifies a priority update message to another AF related to the service.

Step 7e: Another AF returns an ACK message.

It should be noted that steps 6e and 7e are optional. If another AF subscribes to the priority update message from the PCRF at the stage of initiating a service of the MS/user, the PCRF may notify the corresponding AF as described in steps 6e and 7e.

It should be specified that the PCC architecture may be applied to both a 3GPP network and a WiMAX network. Nevertheless, the 3GPP network and the WiMAX network may not employ the PCC architecture. This embodiment deals with how to change a priority of a type of, multiple types of, or all types of services of a user through a serving ASN functional entity in a WiMAX network that is not based on PCC architecture. Certainly, in a 3GPP network, an entity with the same function may be set to undertake a function of the serving ASN functional entity in the WiMAX network.

In the service priority update methods provided in the foregoing embodiments, the priority management functional entity for uniformly managing the priority information of user services is used to change the priority of a type of, multiple types of, or all types of services as required by the user, which improves QoS.

A person skilled in the art should understand that all or part of steps of methods in the embodiments of the present invention may be implemented by a program instructing relevant hardware. The program may be stored in a computer readable storage medium. When the program is executed, the steps of the methods in the embodiments of the present invention are performed. The storage medium may be any medium capable of storing a program code, such as a Read Only Memory (ROM), a Random Access Memory (RAM), a magnetic disk, or a Compact Disk-Read Only Memory (CD-ROM).

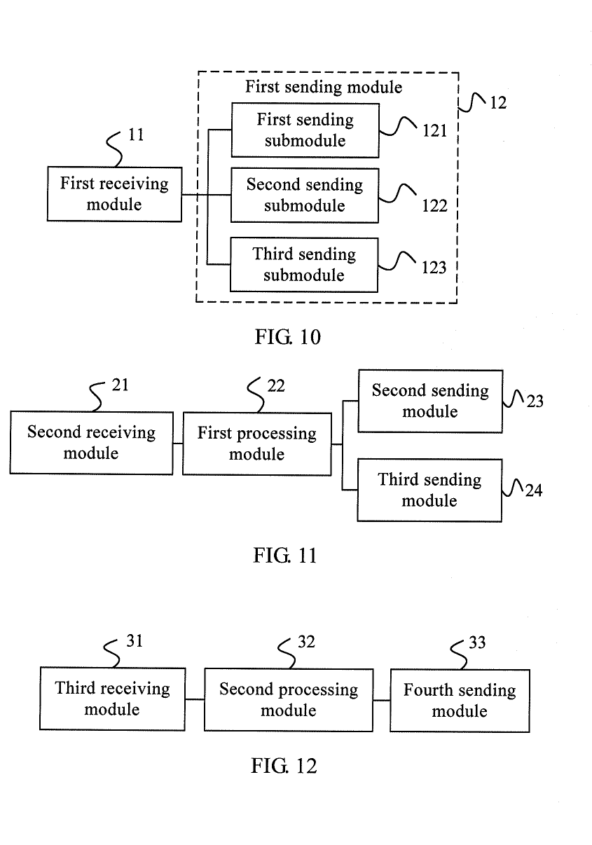

FIG. 10 is a schematic structural diagram of a priority management functional entity device according to an embodiment of the present invention. As shown in FIG. 10, the priority management functional entity device includes: a first receiving module 11, configured to receive a service priority update request message sent by a user, where the update request message includes a service type identifier and a priority update indication identifier corresponding to the service type identifier; and a first sending module 12, configured to send a service priority update instruction message to a network side according to the update request message, where the update instruction message is used to instruct the network side to process a service corresponding to the service type identifier according to a priority level corresponding to the priority update indication identifier.

Specifically, when the user needs to increase a priority of a type of, multiple types of, or all types of services, the user interacts with the priority management functional entity device. The first receiving module 11 in the priority management functional entity device receives the service priority update request message sent by the user, where the update request message may carry one or several service type identifiers or a special identifier that is used to identify all service types. Specifically, if the update request message carries only one service type identifier, it indicates that the user needs to update priority information of only one type of services; if the update request message carries several service type identifiers, it indicates that the user needs to update priority information of several types of services at the same time; if the update request message carries a special identifier such as “ALL” that is used to identify all service types, it indicates that the user needs to update priority information of all types of services. Moreover, a priority update indication identifier includes a priority state update indication identifier or a priority level update indication identifier. Specifically, if a priority of a service of a user includes only an ETS-active state and an ETS-inactive state, a priority state update indication identifier may be sent to the ETS server to indicate that the user needs to update from the ETS-inactive state to the ETS-active state, and a priority level of a service in the ETS-active state is higher than a priority level of a service in the ETS-inactive state. If a priority of a service of a user includes not only the ETS-active state and ETS-inactive state, but also multiple priorities for the user to select in the ETS-active state, the user may select a corresponding priority level according to a priority level update indication identifier corresponding to each priority level. In both of the foregoing two circumstances, an identifier transmitted between the user and the priority management functional entity device may be preset.

The priority management functional entity receives the service priority update request message sent by the user, and directly or indirectly sends the service priority update request message to the network side through the first sending module 12, where the message instructs the network side to process a service corresponding to the service type identifier according to a priority level corresponding to the priority update indication identifier. The first sending module 12 includes any one or any combination of the following submodules to implement a priority update in various circumstances: a first sending submodule 121, a second sending submodule 122, and a third sending submodule 123. The first sending submodule 121 is configured to directly send a service priority update instruction message to the PCRF. The second sending submodule 122 is configured to indirectly send a service priority update instruction message to the PCRF through an SPR or an AAA server. Specifically, the second sending submodule 122 is configured to send a service priority update instruction message to the SPR or the AAA server, and then the SPR or the AAA server forwards the update instruction message to the PCRF; or, the second sending submodule 122 is configured to send a service priority update instruction message to the SPR or the AAA server, the SPR or the AAA server forwards the update instruction message to a PCEF, and then the PCEF forwards the update instruction message to the PCRF. The third sending submodule 123 is also configured to indirectly send a service priority update instruction message to the PCRF. Specifically, the third sending submodule 123 is configured to send a service priority update instruction message to a USI server, and the USI server forwards the update instruction message to the PCRF.

This embodiment is based on PCC architecture, and a priority management functional entity device for uniformly managing the priority information of user services is added in the network to enable a user to change a priority of a type of, multiple types of, or all types of services of the user as required, which improves QoS.

FIG. 11 is a schematic structural diagram of a PCRF device according to an embodiment of the present invention. As shown in FIG. 11, the PCRF device includes a second receiving module 21, a first processing module 22, and a second sending module 23. The second receiving module 21 is configured to receive a service priority update instruction message, where the update instruction message includes a service type identifier and a priority update indication identifier corresponding to the service type identifier. The first processing module 22 is configured to create a service priority update rule according to the service type identifier and the priority update indication identifier. The second sending module 23 is configured to send the service priority update rule to a PCEF, and instruct the PCEF to process a service corresponding to the service type identifier according to a priority level corresponding to the priority update indication identifier.

Specifically, the second receiving module 21 directly or indirectly receives the service priority update instruction message that is sent by a priority management functional entity, and then the first processing module 22 formulates a corresponding PCC rule according to the received update instruction message. Specifically, the PCRF needs to know a new priority level, determine all sessions related to a service type whose priority needs to be updated, and associate the sessions with the new priority level to form a new priority rule. It should be noted that if the user sets up a new session actively or passively (for example, a network requests setting up of a session with the user), and a type of this session is the same as the service type whose priority needs to be updated, a priority level of the new session is determined according to the priority update indication identifier. That is, the updated priority is applied to the new session. Finally, the second sending module 23 is configured to send the service priority update rule to the PCEF, and instructs the PCEF to enforce the rule.

Besides, the PCRF provided in this embodiment further includes a third sending module 24, configured to send a service priority update notification message to all AFs (the AFs may include an SPR or an AAA server, and an IMS AF) related to a session determined by the service type identifier. The notification message includes the service type identifier and the priority level corresponding to the priority update indication identifier, and the session is determined according to the service type identifier.

The PCRF device provided in this embodiment is based on PCC architecture, and exercises priority control on all types of services of the user in an emergency. An ETS imposes a new requirement on the PCRF, that is, the PCRF needs to increase a priority of a type of, multiple types of, or all types of services of the user at the same time, which may involve sessions related to several AFs, and therefore improves QoS.

FIG. 12 is a schematic structural diagram of a serving ASN functional entity device according to an embodiment of the present invention. As shown in FIG. 12, the serving ASN functional entity device includes a third receiving module 31 and a second processing module 32. The third receiving module 31 is configured to receive a service priority update instruction message, where the update instruction message includes a service type identifier and a priority update indication identifier corresponding to the service type identifier. The second processing module 32 is configured to process a service corresponding to the service type identifier according to a priority level corresponding to the priority update indication identifier.

Specifically, in a system (such as a WiMAX system) that is not based on PCC architecture, a priority management functional entity sends the service priority update instruction message to an SPR or an AAA server, and the SPR or the AAA server forwards the update instruction message to the serving ASN functional entity device. The third receiving module 31 in the serving ASN functional entity device receives the service priority update instruction message. The priority update indication identifier in the update instruction message includes a priority state update indication identifier or a priority level update indication identifier; and the service type identifier includes one or several service type identifiers, or a special identifier that is used to identify all types of services. Then, the second processing module 32 increases, according to the indication, a priority of a service type specified by the user to a priority expected by the user, and processes a corresponding service according to the new priority.

In addition, the serving ASN functional entity device provided in this embodiment further includes a fourth sending module 33, configured to send a service priority update notification message to all AFs related to a session determined by the service type identifier. The notification message includes the service type identifier and the priority level corresponding to the priority update indication identifier, and the session is determined according to the service type identifier.

It should be noted that the PCC architecture may be applied to both a 3GPP network and a WiMAX network. Nevertheless, the 3GPP network and the WiMAX network may not employ the PCC architecture. The serving ASN functional entity device in this embodiment may be applied to a WiMAX network that is not based on PCC architecture. In a 3GPP network that is not based on the PCC architecture, a functional entity similar to the serving ASN functional entity device may be set to undertake a same function. The serving ASN functional entity device provided in this embodiment exercises priority control on all types of services of the user in an emergency without being based on PCC architecture. An ETS imposes a new requirement on the serving ASN functional entity device, that is, the serving ASN functional entity device needs to increase a priority of a type of, multiple types of, or all types of services of the user at the same time, which may involve sessions related to several AFs, and therefore improves QoS.

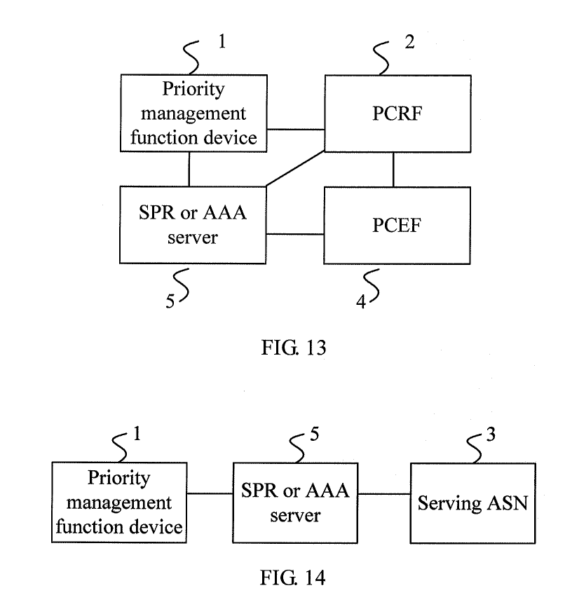

FIG. 13 is a schematic structural diagram of a network system according to a first embodiment of the present invention. As shown in FIG. 13, the network system provided in this embodiment includes a priority management functional entity device 1 and a PCRF 2. The priority management functional entity device 1 is configured to: receive a service priority update request message sent by a user, where the update request message includes a service type identifier and a priority update indication identifier corresponding to the service type identifier; and send a service priority update instruction message to a network side according to the update request message, where the update instruction message is used to instruct the network side to process a service corresponding to the service type identifier according to a priority level corresponding to the priority update indication identifier. The PCRF 2 is configured to: receive the service priority update instruction message, create a service priority update rule according to the service type identifier and the priority update indication identifier, send the service priority update rule to a PCEF 4, and instruct the PCEF 4 to process the service corresponding to the service type identifier according to the priority level corresponding to the priority update indication identifier.

The network system further includes the PCEF 4, configured to receive the service priority update rule sent by the PCRF 2, and process the service corresponding to the service type identifier according to the priority level corresponding to the priority update indication identifier. The network system may further include an SPR 5 or an AAA server 5, configured to: forward to the PCEF 4 the service priority update instruction message sent by the priority management functional entity device 1; for another implementation mode, the SPR 5 or the AAA server 5 in this embodiment may be further configured to, after receiving the service priority update instruction message sent by the priority management functional entity device 1, forward the service priority update instruction message to the PCEF 4, and instruct the PCEF 4 to send the service priority update instruction message to the PCRF 2.

In this embodiment, the network system based on PCC architecture exercises priority control on all types of services of the user in an emergency; after the PCRF modifies sessions of a type of, multiple types of, or all types of services of the user, the network system may notify priority update information to a relevant AF, which improves QoS. The functional entity devices involved in the network system that is provided in this embodiment may be the same as the function devices provided in the foregoing method embodiments and apparatus embodiments, and are not described here.

FIG. 14 is a schematic structural diagram of a network system according to a second embodiment of the present invention. As shown in FIG. 14, another network system provided in an embodiment of the present invention includes a priority management functional entity device 1, an SPR 5 or an AAA server 5, and a serving ASN functional entity 3. The priority management functional entity device 1 is configured to: receive a service priority update request message sent by a user, where the update request message includes a service type identifier and a priority update indication identifier corresponding to the service type identifier; and send a service priority update instruction message to the SPR 5 or the AAA server 5 according to the update request message, where the update instruction message is used to instruct the serving ASN functional entity 3 to process a service corresponding to the service type identifier according to a priority level corresponding to the priority update indication identifier. The serving ASN functional entity 3 is configured to: receive the service priority update instruction message, and process the service corresponding to the service type identifier according to the priority level corresponding to the priority update indication identifier.

In this embodiment of the present invention, the network system in non-PCC architecture exercises priority control on all types of services of the user in an emergency; after the serving ASN functional entity modifies sessions related to a type of, multiple types of, or all types of services of the user, the network system may notify a priority update information to a relevant AF, which improves QoS. The function devices involved in the network system that is provided in this embodiment may be the same as the function devices provided in the foregoing method embodiments and apparatus embodiments, and are not described here.

Finally, it should be noted that the foregoing embodiments are merely used to describe the technical solutions of the present invention, but not intended to limit the present invention. Although the present invention has been described in detail with reference to the foregoing embodiments, it is apparent that a person skilled in the art may make various modifications and variations to the invention without departing from the spirit and scope of the invention. The present invention is intended to cover the modifications and variations provided that they fall within the scope of protection defined by the following claims or equivalents thereof.

1. A service priority update method, comprising:
receiving a service priority update instruction message, wherein the update instruction message comprises a service type identifier and a priority update indication identifier corresponding to the service type identifier; and
updating a priority of a service corresponding to the service type identifier according to a priority level corresponding to the priority update indication identifier.

2. The service priority update method according to claim 1, wherein:
the priority update indication identifier comprises one of a priority state update indication identifier or a priority level update indication identifier; and the service type identifier comprises at least one service type identifiers, or an identifier that is used to identify all types of services.

3. The service priority update method according to claim 1, further comprising:
receiving, by a Policy Control and Charging Rules Function (PCRF), the service priority update instruction message sent by a priority management functional entity, wherein the update instruction message comprises the service type identifier and the priority update indication identifier corresponding to the service type identifier;
creating, by the PCRF, a service priority update rule according to the service type identifier and the priority update indication identifier; and
sending, by the PCRF, the service priority update rule to a Policy and Charging Enforcement Function (PCEF), and instructing the PCEF to update the priority of the service corresponding to the service type identifier according to the priority level corresponding to the priority update indication identifier.

4. The service priority update method according to claim 2, further comprising:
receiving, by a Policy Control and Charging Rules Function (PCRF), the service priority update instruction message sent by a priority management functional entity, wherein the update instruction message comprises the service type identifier and the priority update indication identifier corresponding to the service type identifier;
creating, by the PCRF, a service priority update rule according to the service type identifier and the priority update indication identifier; and
sending, by the PCRF, the service priority update rule to a Policy and Charging Enforcement Function (PCEF), and instructing the PCEF to update the priority of the service corresponding to the service type identifier according to the priority level corresponding to the priority update indication identifier.

5. The service priority update method according to claim 3, wherein:
the creating the service priority update rule according to the service type identifier and the priority update indication identifier comprises:
determining a relevant session according to the service type identifier, and establishing an association between the session and the priority level corresponding to the priority update indication identifier.

6. The service priority update method according to claim 5, further comprising:
determining, by the PCRF, an Application Function (AF) related to the session;
sending, by the PCRF, a service priority update notification message to the AF, wherein the notification message comprises the service type identifier and the priority level corresponding to the priority update indication identifier.

7. The service priority update method according to claim 6, wherein:
the creating the service priority update rule further comprises:
if a type of a new session set up by the user is a type corresponding to the service type identifier, determining, according to the priority update indication identifier, a priority level of the new session.

8. The service priority update method according to claim 3, wherein:
the receiving the service priority update instruction message comprises one of:
receiving, by the PCRF, the service priority update instruction message sent by the priority management functional entity;
receiving, by the PCRF, the service priority update instruction message sent by the priority management functional entity through a Universal Services Interface (USI) server;
receiving, by the PCRF, the service priority update instruction message sent by the priority management functional entity through a Subscription Profile Repository (SPR) or an Authentication, Authorization and Accounting (AAA) server; or
receiving, by the PCRF, the service priority update instruction message sent by the priority management functional entity through the SPR or the AAA server, and then through the PCEF.

9. The service priority update method according to claim 1, comprising:
receiving, by a serving Access Service Network (ASN) functional entity, the service priority update instruction message, wherein the update instruction message comprises the service type identifier and the priority update indication identifier corresponding to the service type identifier; and
updating, by the serving ASN functional entity, the priority of the service corresponding to the service type identifier according to the priority level corresponding to the priority update indication identifier.

10. A priority management functional entity device, comprising:
a first receiving module, configured to receive a service priority update request message sent by a user, wherein the update request message comprises a service type identifier and a priority update indication identifier corresponding to the service type identifier; and
a first sending module, configured to send a service priority update instruction message to a network side according to the update request message, wherein the update instruction message is used to instruct the network side to update a priority of a service corresponding to the service type identifier according to a priority level corresponding to the priority update indication identifier.

11. The priority management functional entity device according to claim 10, wherein the first sending module comprises at least one or any combination of the following submodules:
a first sending submodule, configured to send the service priority update instruction message to a Policy Control and Charging Rules Function (PCRF);
a second sending submodule, configured to send the service priority update instruction message to a Subscription Profile Repository (SPR) or an Authentication, Authorization and Accounting (AAA) server; and
a third sending submodule, configured to send the service priority update instruction message to a Universal Services Interface (USI) server.

12. A Policy Control and Charging Rules Function (PCRF) device, comprising:
a second receiving module, configured to receive a service priority update instruction message, wherein the update instruction message comprises a service type identifier and a priority update indication identifier corresponding to the service type identifier; and
an updating module, configured to update a priority of a service corresponding to the service type identifier according to a priority level corresponding to the priority update indication identifier.

13. The PCRF device according to claim 12, wherein the updating module comprises: a first processing module, configured to create a service priority update rule according to the service type identifier and the priority update indication identifier;
a second sending module, configured to send the service priority update rule to a Policy and Charging Enforcement Function (PCEF), and instruct the PCEF to update the priority of the service corresponding to the service type identifier according to a priority level corresponding to the priority update indication identifier.

14. The PCRF device according to claim 12, further comprising:
a third sending module, configured to send a service priority update notification message to an Application Function (AF) related to a session determined by the service type identifier, wherein the notification message carries the service type identifier and the priority level corresponding to the priority update indication identifier.

15. A network system, comprising:
a priority management functional entity, configured to: receive a service priority update request message sent by a user, wherein the update request message comprises a service type identifier and a priority update indication identifier corresponding to the service type identifier; and send a service priority update instruction message to a Policy Control and Charging Rules Function (PCRF) according to the update request message;
the PCRF, configured to: receive the service priority update instruction message, create a service priority update rule according to the service type identifier and the priority update indication identifier, and send the service priority update rule to a Policy and Charging Enforcement Function (PCEF); and
the PCEF, configured to receive the service priority update rule sent by the PCRF, and update a priority of a service corresponding to the service type identifier according to a priority level corresponding to the priority update indication identifier.
